(19) United States
(12) Patent Application Publication
(10) Pub. No.: US 2026/0086216 A1
(43) Pub. Date: Mar. 26, 2026

(54) DETECTING ARTIFICIAL FACIAL PRESENTATION ATTACK INSTRUMENTS

(71) Applicant: Mobai AS, Gjøvik (NO)

(72) Inventor: Raghavendra Ramachandra, Gjøvik (NO)

(21) Appl. No.: 18/892,970

(22) Filed: Sep. 23, 2024

(51) Int. Cl. G01S 7/539

(52) U.S. Cl. CPC G01S 7/539

(57) ABSTRACT

The present disclosure relates to a method of determining whether a presented face comprises an artificial facial presentation attack instrument. The method comprises: transmitting an airborne acoustic signal towards the presented face; receiving acoustic emissions from the presented face arising from the airborne acoustic signal; sampling the received acoustic emissions to generate a sampled response signal; applying one or more wavelet transforms to the sampled response signal to generate a wavelet-transformed signal; processing the wavelet-transformed signal using a model, wherein the model has been trained using training data comprising wavelet-transformed signals for distinguishing between presented faces that comprise artificial facial presentation attack instruments and presented faces that do not comprise artificial facial presentation attack instruments; and determining, in dependence upon an output of the model, whether the presented face comprises an artificial facial presentation attack instrument.

### TECHNICAL FIELD

The present disclosure relates to methods, apparatus and software for determining whether a presented face comprises an artificial facial presentation attack instrument.

### BACKGROUND

It is known that bad faith actors (also known as attackers) can seek to circumvent facial biometric systems for various purposes such as evasion or theft. Facial biometric systems capture information regarding the facial biometric features of a person that may be useful for authenticating or identifying the person. For instance, Face Recognition systems (FRS) are a common type of facial biometric system used in applications such as banking or building security to provide access only to an authorized user or users.

One method of circumventing facial biometric systems is known as a presentation attack (PA), where an attacker presents an artificial facial presentation attack instrument (PAI), also known as a facial PA artefact, to maliciously bypass a facial biometric system by presenting one or more artificial facial biometric features that are not part of the attacker's own face. For instance, an attacker may attempt to gain access to a victim's bank account by performing a presentation attack on the bank's facial recognition system using a presentation attack instrument, such as a latex mask, that mimics one or more of the victim's facial biometric features.

Such a presentation attack instrument may comprise a sheet of paper bearing a printed partial or full facial image, or an electronic display showing a partial or full facial image, or a three-dimensional model or mask, e.g. made of latex or silicone, of part or all of a human face. The presentation attack instrument may represent a complete face or only a portion of a face. It may be presented to a facial biometric system on its own, or with a genuine human face such as a mask worn over part of the attacker's face (e.g. covering all of the face except for the attacker's eyes).

There is therefore a need to prevent attackers from bypassing facial biometric systems by determining whether a presentation attack instrument is being presented, and thereby detect whether a presentation attack is occurring or if bona-fide facial biometric features are being presented.

Embodiments of the present disclosure seek to provide novel methods for determining whether a presented face (which could be a real face or an at-least-partially fake face) comprises an artificial facial presentation attack instrument (e.g. someone wearing a mask).

### SUMMARY

Disclosed here is a method of determining whether a presented face comprises an artificial facial presentation attack instrument, the method comprising:
transmitting an airborne acoustic signal towards the presented face;
receiving acoustic emissions from the presented face arising from the airborne acoustic signal;
sampling the received acoustic emissions to generate a sampled response signal;
applying one or more wavelet transforms to the sampled response signal to generate a wavelet-transformed signal;
processing the wavelet-transformed signal using a model, wherein the model has been trained using training data comprising wavelet-transformed signals for distinguishing between presented faces that comprise artificial facial presentation attack instruments and presented faces that do not comprise artificial facial presentation attack instruments; and
determining, in dependence upon an output of the model, whether the presented face comprises an artificial facial presentation attack instrument.

Also disclosed is computer software (which may be stored on a non-transitory computer-readable medium) comprising instructions which, when executed on a processing system of an electronic device (e.g. a smartphone) cause the electronic device to perform a method as disclosed herein.

Also disclosed is an electronic device (e.g. a smartphone) configured to perform a method as disclosed herein. The electronic device may be configured to perform one or more of the steps in response to computer software executing on a processing system of the device. The electronic device may comprise an acoustic transmitter (e.g. a loudspeaker) for transmitting the airborne acoustic signal and an acoustic receiver (e.g. a microphone) for receiving the acoustic emissions. These may comprise separate transducers or a same transducer.

Transmission of the airborne acoustic signal may cease at a first time. The received acoustic emissions may be sampled during a time window starting after the first time. There may be an interval between the first time and the start of the time window. This “wait” interval may be long enough to avoid sampling the transmitted airborne acoustic signal. The interval may be 0.05 seconds in some embodiments, while in other embodiments it may be longer, e.g. 0.1 or 0.5 seconds. It may be long enough to avoid sampling one or more, or all, direct reflections of the airborne acoustic signal from an outer surface of the presented face.

This use of a wait interval may be beneficial even in methods that do not use a model that has been trained using training data comprising wavelet-transformed signals. Thus, also disclosed here is a method of determining whether a presented face comprises a facial presentation attack instrument, the method comprising:
transmitting an airborne acoustic signal from an acoustic transmitter towards the presented face;
ceasing transmission of the airborne acoustic signal at a first time;
one or more direct reflections of the airborne acoustic signal from an outer surface of the presented face arriving at an acoustic receiver during a first time window starting after the first time;
receiving, at the acoustic receiver, during a second time window starting after an end of the first time window, one or more further acoustic emissions from the presented face, arising from the airborne acoustic signal;
sampling the one or more further acoustic emissions to generate a sampled response signal; and
processing the sampled response signal to determine, in dependence upon the one or more further acoustic emissions, whether the presented face comprises a facial presentation attack instrument.

The method may comprise processing the sampled response signal to determine, only in dependence upon the one or more further acoustic emissions, whether the presented face comprises a facial presentation attack instrument—i.e. not in dependence upon any acoustic emissions received at the acoustic receiver during the first time window.

In some embodiments, the one or more direct reflections of the airborne acoustic signal may be received at the acoustic receiver but not sampled.

This method may, in some embodiments, additionally comprise processing the sampled response signal using a model, wherein the model has been trained for distinguishing between presented faces that comprise artificial facial presentation attack instruments and presented faces that do not comprise artificial facial presentation attack instruments.

Any of the methods disclosed herein may comprise sampling background noise to generate a background noise signal and using the background noise signal to remove background noise from the sampled response signal, e.g. before applying the one or more wavelet transforms to the sampled response signal. The method may comprise sampling the background noise prior to transmitting the airborne acoustic signal.

The methods may comprise transmitting the airborne acoustic signal for at least 0.1 seconds, preferably at least 1 second, and preferably at least 2 seconds.

Any of the methods disclosed herein may comprise sampling the received acoustic emissions for at least 0.1 seconds, preferably at least 1 second, and preferably at least 1.5 seconds.

The airborne acoustic signal may be a rectangular pulse. The airborne acoustic signal may be or comprise a sinusoidal tone, e.g. a sine wave having a frequency between 20 kHz and 22 kHz, such as 21 kHz.

The one or more wavelet transforms may comprise a plurality of wavelet transforms, wherein each wavelet transform is different. Different wavelets enable the extraction of different time-frequency information from the sampled response signal to generate a component of the wavelet-transformed signal. The sampled response signal may be passed through a continuous wavelet transform filter bank, which may comprise ten or more wavelet bandpass filters. Each wavelet transform may use a respective Morse wavelet, optionally wherein the Morse wavelet is symmetric in the frequency domain.

The model may comprise an artificial neural network (preferably a convolutional neural network) and a classifier module, wherein the classifier module is arranged to receive data (e.g. one or more deep features) generated using the artificial neural network (ANN). The classifier module may be configured to process the data to determine a score (e.g. in dependence upon an output of the artificial neural network), representing a probability that the presented face comprises an artificial facial presentation attack instrument. The score may represent this probability in any appropriate way and need not itself be a true probability (e.g. it may, in some embodiments, be able to have a value below zero and/or greater than one).

The ANN may be pre-trained. It may be pre-trained on images of a dataset to classify those images. It may be pre-trained on the ImageNet dataset. The pre-training may use a pre-training classifier that is not present in the present model. Instead, the present model comprises a classifier module that has been trained using the training data comprising wavelet-transformed signals for distinguishing between presented faces that comprise artificial facial presentation attack instruments and presented faces that do not comprise artificial facial presentation attack instruments. In embodiments in which the ANN is pre-trained, the model may be trained by training the classifier module, optionally wherein the ANN is not further trained. I.e. in some embodiments the ANN is not trained using the training data comprising wavelet-transformed signals (although it may be used in the training of the classifier module).

Methods disclosed herein may comprise a further step of training the model. In embodiments in which the model comprises an ANN and a classifier module, the training may comprise inputting the training data to the model (e.g. to the ANN) and training the classifier module on the training data. In some embodiments, the ANN is not trained while the model is trained (e.g. it may have been pre-trained on a different dataset).

Determining whether the presented face comprises an artificial facial presentation attack instrument may comprise comparing the score against a threshold to classify the presented face as comprising an artificial facial presentation attack instrument (i.e. indicative of a presentation attack occurring) or as not comprising an artificial facial presentation attack instrument (i.e. being bona fide). This may be done by a decision module that is arranged to receive the score from the classifier module.

The artificial neural network may be a convolutional neural network (CNN). The artificial neural network may be configured to determine and/or output (e.g. to a classifier) two or more deep features (feature vectors). Each deep feature may be separate and may relate to a different set of input nodes of the artificial neural network. The method may comprise determining a sub-score for each of the deep features, and combining (i.e. fusing) the sub-scores to determine the score.

In some embodiments, a single deep feature (single feature vector) may be received by the classifier from the artificial neural network, optionally wherein the artificial neural network comprises a fully connected final layer to extract the single deep feature.

The classifier may comprise one or more support vector machines. In some embodiments, the classifier may comprise a support vector machine for each deep feature received by the classifier from the artificial neural network. The classifier module may comprise a fusion stage configured to fuse values generated by a plurality of support vector machines.

The presented face may be a presentation attack instrument on its own, or it may comprise a real face in combination with a presentation attack instrument. The presentation attack instrument may partially or fully mask the real face.

The model may have been trained for detecting presented faces that comprise artificial facial presentation attack instruments comprising a displayed image (e.g. a printed image and/or an electronically-displayed image) and/or a mask (e.g. a two-dimensional mask and/or a three-dimensional mask) and/or a dummy head.

Optionally, the model has been trained using training data comprising labeled wavelet-transformed signals for distinguishing between presented faces that comprise artificial facial presentation attack instruments and presented faces that do not comprise artificial facial presentation attack instruments. The wavelet-transformed signals may be derived from acoustic signals characteristic of presented faces from both these categories. These acoustic signals may comprise sampled acoustic signals and/or synthetic data that may be generated from simulations or from augmenting sampled acoustic signals. Where labeled training data is used, the model may be trained to generate data (e.g. as input to a classifier) for classifying the presented face as either a real face or an artificial face. Where unlabeled training data is used, the model may be trained to generate data for clustering the training data into two clusters (i.e. into a first cluster representing presented faces that comprise artificial facial presentation attack instruments and a second cluster representing presented faces that do not comprise artificial facial presentation attack instruments). The model may be trained in a supervised and/or unsupervised manner.

A determination of whether the presented face comprises an artificial facial presentation attack instrument may be stored in a memory (e.g. a memory of the electronic device). The device may be configured to provide a service only when the presented face does not comprise an artificial facial presentation attack instrument (and optionally when one or more further conditions are met). The electronic device may be configured to implement a facial biometric system which may comprise a facial recognition system. The device may comprise a camera for use by the facial biometric system. Methods disclosed herein may further comprise using a camera to sample an image of the presented face, and processing the image to authenticate or identify a user. Some embodiments may be configured to perform this processing only when the presented face has first been determined not to comprise an artificial facial presentation attack instrument. The facial recognition system may be configured to compare facial biometric features, e.g. obtained using the camera, against stored biometric facial features of one or more authorized users. However, this is not essential, and in some embodiments the detection of artificial facial presentation attack instruments may be useful even without biometric identification or authentication, e.g. where it is desirable to detect presentation attacks which could indicate malice.

Features of any embodiment described herein may, wherever appropriate, be applied to any other embodiment described herein. Where reference is made to different embodiments or sets of embodiments, it should be understood that these are not necessarily distinct but may overlap.

### BRIEF DESCRIPTION OF THE DRAWINGS

Certain embodiments will now be described, by way of example only, with reference to the accompanying drawings, in which:

FIG. 1 is a schematic illustration of a user and a device comprising a facial biometric system;

FIG. 2 is a schematic of the device according to FIG. 1;

FIG. 3 is a time plot of an exemplary transmitted acoustic signal and a subsequent receive window;

FIG. 4 shows a pair of graphs of amplitude against time for two exemplary received acoustic signals;

FIG. 5 is a schematic diagram of a system for detecting a presentation attack against a facial biometric system;

FIG. 6 qualitatively plots wavelet-transformed signals for a bona fide presented face and for presentation attacks;

FIG. 7 shows four tables of quantitative performance of methods embodying the present disclosure without background subtraction;

FIG. 8 plots D-EER (%) of methods embodying the present disclosure on intra (upper plot) and inter (lower plot) experiments without background subtraction;

FIG. 9 shows four tables of quantitative performance of methods embodying the present disclosure with background subtraction;

FIG. 10 plots D-EER (%) of methods embodying the present disclosure on intra (upper plot) and inter (lower plot) experiments with background subtraction;

FIG. 11 plots average D-EER (%) of inter and intra experiments without background subtraction (upper plot) and with background subtraction (lower plot).

### DETAILED DESCRIPTION OF EMBODIMENTS

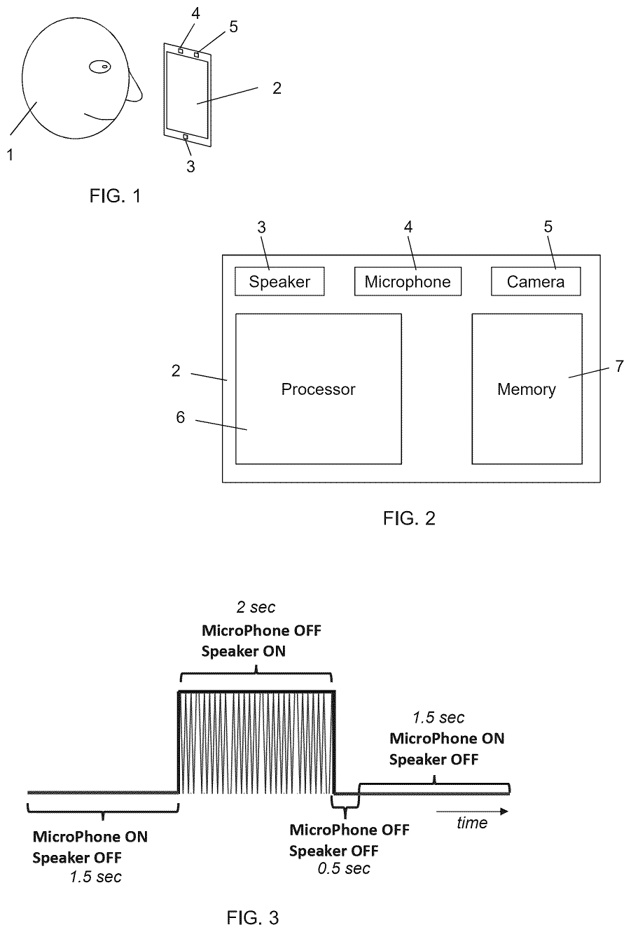

FIG. 1 shows a person 1 using a device 2, such as a smartphone, that embodies aspects of the present disclosure. The device 2 comprises a speaker 3, a microphone 4, and a camera 5. FIG. 2 shows a schematic of the device of FIG. 1, further showing a processor 6 (e.g. a CPU and/or GPU and/or DSP) and a memory 7 inside the device 2.

In order to verify that the person 1 is not an attacker, but rather a legitimate user, the device 2 comprises an optical facial recognition system for authenticating the person 1, using the camera 5.

In order to protect the device 2 from presentation attacks against this recognition system, in which a malicious attacker presents a presentation attack instrument to the camera 5, the facial biometric system of the device 2 is additionally configured for detecting presentation attacks. It does so acoustically, using the speaker 3 to transmit an acoustic signal and the microphone 4 to receive an acoustic signal.

In this setup, the transmitted acoustic signal is directed towards a presented face, which may be the face of the genuine user 1, or an artificial attack instrument presented by a malicious attacker (alone or in combination with the attacker's own face). The transmitted acoustic signal gives rise to acoustic emissions from the presented face that contribute to the acoustic signal received at the microphone 4. The facial biometric system samples at least a portion of the acoustic signal received at the microphone 4 in response to the transmitted signal and analyzes it to determine whether a presentation attack instrument is present and thus whether a presentation attack is occurring.

Types of presentation attack instruments that can be detected by the device 2 include masks, which may provide full or partial coverage of the facial biometric features of a person presented to the device 2, and which may be made from one or more of latex, paper, silicone, hard plastic, soft plastic, etc.

The acoustic analysis may be performed using software stored in the memory 7 and executed by the processor 6.

The acoustic emissions received at the microphone 4 include not only immediate direct reflections of the transmitted signal from an outer surface of the presented face, but also acoustic emissions arising due to resonances or reverberations or scattering or reflections from deeper layers of the presented face. These later-emitted acoustic signals may contain one or more frequencies not present in the transmitted signal, for example at one or more resonant frequencies.

The inventor has determined that, in at least some embodiments, it can be beneficial to analyze only these subsequent acoustic emissions, and not the direct reflections, in order to allow a model to discriminate accurately between unmodified human faces and presentation attack instruments.

The memory 7 may store facial biometric features of the authorized user 1, and the facial biometric system may grant access to the device 2, or to features or services provided by the device, to the authorized user 1 only once the device 2 has determined, using the acoustic system, that a presentation attack is not occurring, i.e. that a bona fide (i.e. genuine unmasked) human face is being presented, and has also authenticated the user 1 using camera-based facial recognition. This second step is done by capturing facial biometric features of the person 1 with the camera 5, which are compared by the processor 6 against the stored facial biometric features in the memory 7, and only granting access when the two match (which will occur when there is a sufficient level of correspondence between the two).

More generally, devices embodying the present disclosure may implement any suitable camera-based facial recognition system, or any other type of facial recognition system, in combination with a novel acoustic presentation-attack detection method as disclosed herein.

Whilst an acoustic signal may be transmitted and used to measure the range (distance) to the bona fide presented face or to the PA artefact, such a functionality is not necessary. Rather, preferably the acoustic signal is a wide rectangular pulse to achieve a sound beam (the straight line that this pulse can travel in space) that can sufficiently impact the bona fide face of the person 1 or PA artefact so that acoustic emissions with sufficient energy can be recorded by the microphone 4 to detect the PAs. Furthermore, it is preferable that the background noise is effectively mitigated by sensing the environment to recover high-quality emissions, such that background noise does not impact or significantly reduce the performance of the system.

FIG. 3 shoes an exemplary acoustic signal that may be transmitted airborne by the speaker 3 of the device 2 in accordance with the present disclosure, where the x axis represents time and the y axis illustrates the amplitude of the signal. FIG. 3 also illustrates the operation of the speaker 3 and microphone 4 in the device 2. These operations are labeled as turned ON or OFF, but it should be appreciated that this is used to refer to whether or not the speaker 3 is transmitting and to whether the microphone 4 is being used to sample acoustic signals that are then analyzed, rather than necessarily whether drive circuitry for these devices is having power supplied to them. In particular, the microphone 4 will be physically receiving acoustic signals from the environment all the time; it may, in some examples, even be sampling incoming signal during periods indicated here as “OFF”; however, only energy received during the “ON” period is used in the detection of PAs.

Initially, before the time represented in FIG. 3, both the speaker 3 and microphone 4 are OFF. Then, during a period of 1.5 seconds, the speaker 3 is OFF (i.e. not transmitting) and the microphone 4 is ON. Next, an acoustic signal is transmitted for 2 seconds, with the microphone 4 OFF. The acoustic signal transmission ceases at a first point in time. After this, during a first time window lasting 0.5 seconds, following this first point in time, the microphone 4 and speaker 3 are both OFF. Then, during a second time window lasting 1.5 seconds, the microphone 4 is ON and the speaker 3 remains OFF.

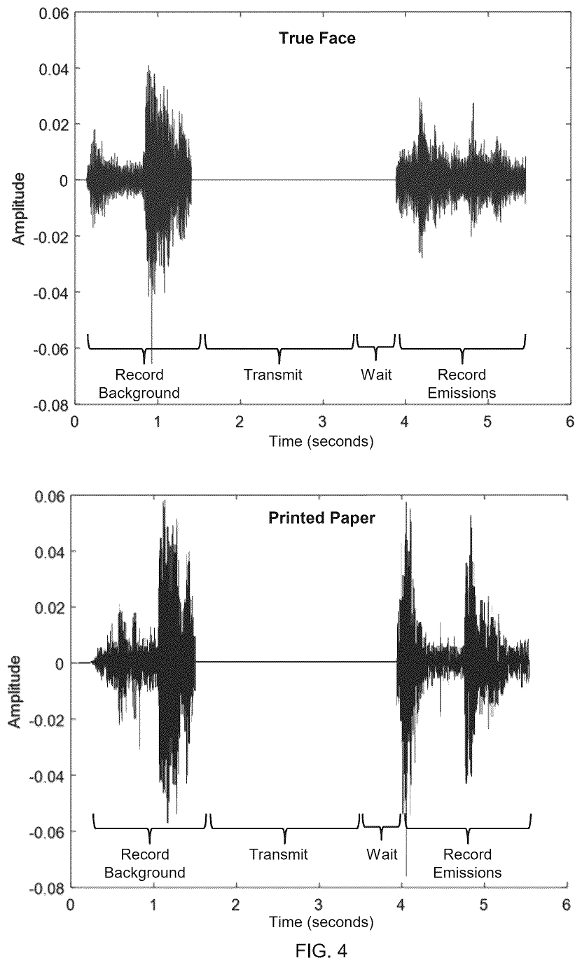

FIG. 4 shows the amplitude of acoustic signals received by the microphone 4 while it is ON, both before and after the transmission of the exemplary acoustic signal in FIG. 3, for each of two different presented faces. The right side of the plot titled “True face” corresponds to acoustic emissions from the person's 1 face when making a bona-fide access attempt (i.e. when no PAI is present and so a PA is not occurring), and the right side of the plot titled “Printed paper” corresponds to acoustic emissions when a sheet of printed paper bearing an image of a face is presented to the device 2.

The exemplary acoustic processing comprises a silent period, a transmission period, a wait period, and a recording period. It should be understood that other acoustic signal processing designs may be used, provided they involve emitting acoustic energy towards a presented face that is subsequently returned and recorded for analysis.

In some embodiments, a silent period occurs before the acoustic transmission, during which the speaker 3 of the device 2 is turned off and the microphone 4 of the device 2 is turned on. During this period, the microphone 4 records background noise, e.g. for 1.5 seconds. Whilst not essential in all embodiments, this recorded background noise can be used to remove background noise from the recording period where the emissions caused by the exemplary acoustic signal are being recorded, which may improve performance. This is conducted prior to the transmission period since this avoids detecting any direct or reflected acoustic signals emitted by the speaker 3 during the transmission period. This recorded background noise can be seen in the first 1.5 seconds of both plots in FIG. 4, for a particular example environment.

The transmission period follows the silent period, during which the microphone 4 of the device 2 is turned off and the speaker 3 of the device 2 is turned on. The speaker 3 emits a sine wave, also known as a pure tone, as a rectangular pulse having a duration of 2 seconds. The pulse duration is chosen to last 2 seconds, rather than a shorter time, because this permits more energy to be transferred to the presented face, thereby enabling stronger emissions to be received using the microphone 4 during the recording period. This creates a larger signal to noise ratio (SNR) in the recorded signal during the recording period. However other durations may be used in other embodiments.

In this exemplary signal, the pure tone has a frequency of 21 kHz. This is because it is desirable to emit a frequency outside the human hearing range, which is commonly given as 20 Hz-20 kHz, such that the person 1 is unaware that the exemplary acoustic signal is being transmitted. However, the majority of microphones 4 in devices 2 such as smartphones support a 44.1 kHz sampling rate for microphones. Thus, the highest frequency which they are able to detect is 22 kHz based on the Nyquist-Shannon sampling theorem. The frequency of 21 kHz is therefore chosen in some embodiments, but other frequencies, which may be audible, can also be used in other embodiments. The microphone 4 is turned off during the transmission period, as can be seen from 1.5 seconds to 3.5 seconds of both plots being zero in FIG. 4, since any acoustic signals recorded during this period will largely be those emitted from the speaker 3. In addition or alternatively to the rectangular pure tone, other waveforms may be emitted during this interval.

Following the transmission period, the inventor has realized that it can also be useful to include a wait period where both the speaker 3 and microphone 4 are turned off for a period of time, such as 0.5 or 0.05 seconds. This avoids the chance of inadvertently recording and analyzing the transmitted signal from the speaker 3 with the microphone 4, thus avoiding direct interference (i.e. sound that travels straight from the speaker 3 to the microphone 4) that can hide desired acoustic signals from the presented face. This can also be seen from 3.5 seconds to 4 seconds of both plots being zero in FIG. 4.

Following the transmission period and the wait period, is the recording period where the speaker 3 is turned off and the microphone 4 is turned on. The recording period lasts 1.5 seconds, and can be seen from 4 seconds to 5.5 seconds of both plots in FIG. 4.

The exemplary acoustic capture period therefore has a total length of 5.5 seconds=1.5 seconds (to record background)+2 seconds (transmitted signal)+0.5 seconds (idle time)+1.5 seconds (recording emissions for analysis).

This has been found to work well with devices 2, such as smartphones, that are held at a distance of 30 to 45 cm from a presented face without obstacles, enabling rich and discriminant information from the signals emitted from the face in order to detect PAs reliably.

As can be seen through a qualitative observation of FIG. 4, the recorded signal portion differs depending upon whether a bona fide or presentation attack is being made. This approach described herein facilitates the capturing of acoustic emissions from bona fide or PA artefacts such that the emission characteristics can be analyzed to detect PAs, whilst also facilitating techniques for mitigating background noise.

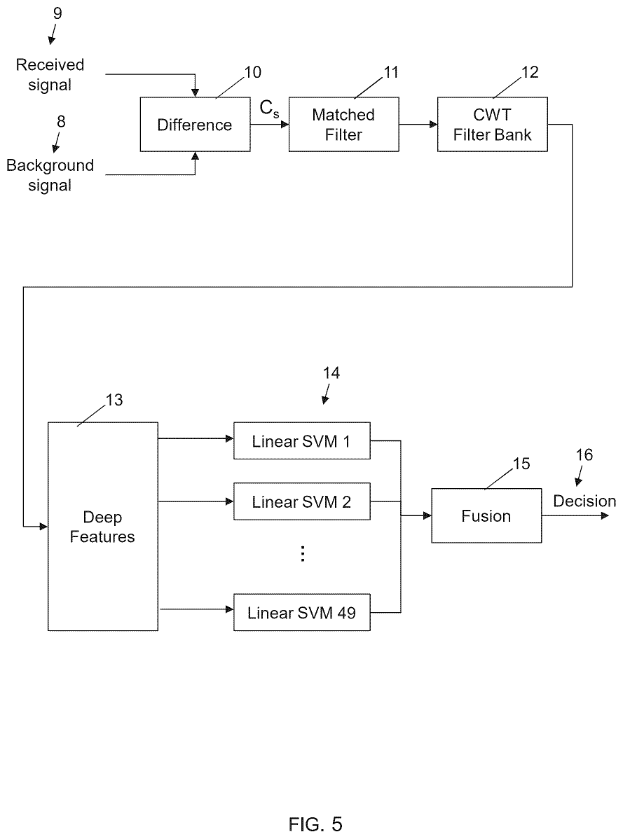

FIG. 5 shows a system architecture (e.g. implemented in software executing on the processor 6 and/or by dedicated hardware) for detecting a presentation attack against a facial biometric system implementing methods disclosed herein. This system comprises the sequential stages of a difference stage 10, a matched filter stage 11, a wavelet transformation stage 12, a deep features extraction stage 13, a detection module stage 14, a fusion stage 15, and a decision stage 16. The detection module stage 14 and the fusion stage 15 may together embody a classifier module as disclosed herein. The deep features extraction stage 13 (which may comprise a convolutional neural network), the detection module stage 14 and the fusion stage 15 may together embody a model as disclosed herein.

Two sampled signals 8 and 9, such as those shown in the left and right portions of each plot in FIG. 4, are provided as an input to the difference stage 10. These are a background signal 8 recorded during the silent period and a received signal 9 recorded during the recording period. The background signal 8 is used to remove background noise from the received signal 9 to obtain a clean signal (Cₛ). The inventor has found that subtraction of one signal from the other to obtain a difference is one possible method of doing so which achieves good performance at a low computational cost. However, other methods of removing background noise are also contemplated herein such as Wiener filtering or by processing the background signal 8 through the wavelet transform stage 12 in parallel with the received signal 8, such that both are provided as inputs for the deep features extraction stage 13 which is trained to remove background noise.

In some embodiments, the clean signal is then passed through a matched filter stage 11 to improve the signal-to-noise ratio through using pulse compression. The matched-filtering operation is performed by correlating the transmitted pulse with the clean signal Cₛ. This produces a processed signal that is passed as an input to the wavelet transformation stage 12. Optionally utilizing a matched filter may help the processed signal better exhibit the traits of the transmitted signal, thereby enhancing the signal-to-noise ratio by reducing noise.

The wavelet transformation stage 12 uses a continuous wavelet transform filter bank (CWT-FB) to extract time-frequency information from the processed signal to capture the emission characteristics of bona fide and presentation attacks. The filter bank is designed for the length of the received signals and in some embodiments uses Morse wavelets, e.g. with a gamma value equal to three and a time-bandwidth product of 60 (with gamma=3, the Morse wavelet is perfectly symmetric in the frequency domain, allowing for a better capture of the time-frequency information). The wavelet transformation stage 12 comprises ten wavelet bandpass filters with the highest-frequency passband set to 20 kHz. Each of these wavelets used in the wavelet transformation stage 12 is used to perform a continuous wavelet transformation of the processed signal.

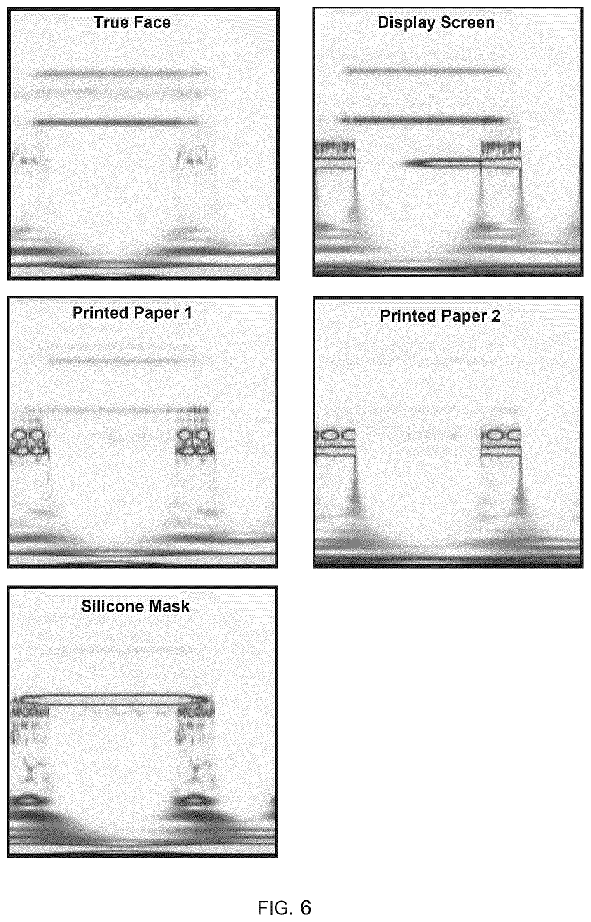

FIG. 6 graphically represents the wavelet-transformed signals for a bona fide presentation (top-left panel, labeled “True Face”) and for four presentation attacks (the remaining panels), with the outputs from the ten wavelet filters being stacked together. It can be seen qualitatively that there are significant differences between the time-frequency responses when presentation attack instruments are used.

The output of the wavelet transformation stage 12 is provided as an input to the deep feature(s) extraction stage 13, which uses an Artificial Neural Network (ANN), which is preferably a Convolutional Neural Network (CNN), to extract deep feature(s) from the time-frequency information. An off-the-shelf pre-trained CNN may be used, such as EfficientNet b0 pretrained on the ImageNet database, for extracting deep feature(s) from the CWT-FB. Although this off-the-shelf CNN might, in some embodiments, be further trained specifically for the present task, in some embodiments no further training of the pre-trained CNN is performed. The CNN may comprise a fully connected layer at its output to extract a single feature vector as the deep feature. However, based on empirical testing it has been advantageously found that extracting two or more separate deep features can provide improved performance in the subsequent decision stage 16, at least in some situations. In this instance, deep features output by a CNN may be understood as being separate when their respective sets of input nodes are different. The respective set of input nodes may be understood as being different when at least one input node is present in one set that is not present in the other. In the particular example of EfficientNet b0, the last Batch Normalization layer is extracted, having a dimension of 7×7×1280 deep features. This results in forty-nine separate deep features of dimension 1×1280 since each of these features arises from a convolution of a different patch (i.e. the input nodes for each feature) of the previous layer.

The deep feature(s) extracted by the CNN are subsequently passed to a detection module stage 14, which performs classification on the deep feature(s) using a classifier to output a detection score indicative of whether or not a presentation attack instrument is present (i.e. whether or not a presentation attack is occurring). When two or more separate deep features are passed to the detection module stage 14, this performs separate classifications on each separate deep feature using separate classifiers to output a detection score indicative of whether or not a presentation attack is occurring for each separate deep feature. This detection score may, in some embodiments, represent a probability (e.g. being a pseudo-probability or confidence value), that the classifier considers there to be a presentation attack occurring.

A linear support vector machine (SVM) trained for this particular task may be used as the classifier, with an SVM classifier used for each separate deep feature that is independently trained for classifying that particular deep feature. In the particular example of EfficientNet b0 where forty-nine separate deep features are extracted, forty-nine SVM classifiers are employed that are trained independently on the forty-nine different features of dimension 1×1280. Where multiple classifiers are used, each of their detection scores is passed to a fusion stage 15 prior to the decision stage 16, where they are combined to form a single detection score. This may be by summing their scores together, or any other suitable operation such as averaging them. In the particular example of EfficientNet b0, the forty-nine detection scores obtained from each independent SVM is summed.

This detection score is then passed to the decision stage 16, where it is compared against a preset threshold to classify the recorded signal 9 as either a bona fide face without any presentation attack instrument, or as indicating the presence of a presentation attack instrument.

### Experimental Validation

What follows below is an experimental write-up of research conducted using approaches disclosed herein. It demonstrate their efficacy in detecting facial presentation attacks. Whilst this section in places stresses the utility or importance of certain features or steps, this should not be taken as an indication that these features or steps are essential in all embodiments.

In this section, we assess some variants of a method for face PA detection based on acoustic signals on a smartphone, embodying the present disclosure. The method was performed substantially as described above, at least in the EfficientNet variant. The method uses only acoustic signals (i.e. not images acquired from a camera) for the generalizable PA detection. The method analyzes reflection echo characteristics to detect bona fides and PAs. The scattering property of the transmitted signal exhibits different characteristics owing to the change in the medium/material properties between the different types of PAIs and bona fide. Therefore, the method uses a single long pulse as the transmission signal to achieve a high signal-to-noise ratio (SNR). Furthermore, the signal design also includes a silence period before transmission of the signal that allows recording of the background noise, which is later subtracted from the received signal to reduce the background noise. After post-processing, the received signal is further represented by time-frequency components computed using continuous wavelet transform (CWT) filter banks. The CWT representation was further processed through EfficientNet, which is a pre-trained deep convolutional neural network, to obtain deep features. Finally, PA detection was performed using a linear SVM to effectively detect the PAs.

### Acoustic Sound Echo Dataset

The experiments were conducted using a newly-collected acoustic sound echo dataset (ASED) comprising 35 data subjects and four different PAIs, including two types of print attacks, display attacks, and silicone face masks. The acoustic signaling (transmission and reflection) system was implemented as an Android application and was installed on a Samsung Galaxy S10. The data were collected in a laboratory setting, particularly in an indoor scenario reflecting the office environment. The user holds the phone so that the frontal camera can show the frontal face of the user. The angle of holding the phone is between 40-60 degrees such that the user can see the face image on the smartphone. Normally, the smartphone-to-face distance is between 20-40 cm. Bona fide data collection was conducted for 20 days in multiple sessions varying from 2 to 10 days, resulting in 35 to 40 samples for each data subject. We employed facial images from the data subjects to generate PAs using different types of artefacts.

For the display attack, we employed iPad Pro 12.9, in which the face image was displayed on a smartphone to collect the data. For the print data, we used two different types of printers. Print-I: The data subject's face images were printed using a LaserJet printer with normal print paper. Print-II: The data subject's face images are printed using the Dye Sublimation printer with a glossy paper. The use of two different types of printers allows for the analysis of the reflection characteristics of the method for detecting PAs. The silicone face mask dataset was collected by wearing the silicone mask of the subject. Owing to the high cost of silicone masks, we used only four silicone face masks to collect the dataset. Thus, the ASED dataset comprised 1433 bona fides, 1234 display attacks, 500 print-I, 500 print-II, and 1140 silicone samples resulting in a total of 4807. This resulted in 4807 samples, including bona fides and PAs.

### Performance Evaluation Protocol

Our protocol to evaluate the attack detection performance divided the entire dataset into two independent sets. The training set consisted of samples collected from 25 subjects and the testing set consisted of samples collected from 10 data subjects. The following table lists the statistics of the training and testing sample distributions used to evaluate the presentation attack detection (PAD) algorithms. However, for the silicone mask data, we have used two silicone masks corresponding to unique identities for training and remaining two for testing.

| Data Type | Train Set | Test Set |
|---|---|---|
| Bona fide | 1003 | 430 |
| Display Attack | 899 | 385 |
| Print-I Attack | 350 | 150 |
| Print-II Attack | 350 | 150 |
| Silicone Attack | 798 | 342 |

### Experimental Results

In this section, we present the quantitative performance of the acoustic-based facial PAD technique. The performance of the face PAD was benchmarked using ISO/IEC 30107-3 metrics such as Attack Presentation Classification Error Rate (APCER) and bona fide Presentation Classification Error Rate (BPCER). APCER is defined as the proportion of attack presentations incorrectly classified as bona fide, whereas BPCER is defined as the portion of the bona fide incorrectly classified as attack presentation. The Detection-Equal Error Rate (D-EER) indicates the value that the proportion of APCER is equal to the portion of BPCER. Extensive experiments were performed to benchmark the performance of the method, highlighting the role of the background noise subtraction employed in the transmission signal design. Furthermore, a comparison with the feature extraction method using EfficientNet (referred to herein as the “EfficientNet method”) was benchmarked against further embodiments of the method using other off-the-shelf pre-trained CNNs-specifically DenseNet, ResNet50 and MobileNetV2.

To effectively analyze the performance of the method for generalizable PAD, we present quantitative results using two different protocols: inter and intra experiment. Inter experiment protocol: In this protocol, the PAD systems were trained and tested with different types of PAI. Hence, this protocol allowed us to analyze the generalizability of the method to unknown PAI. Intra experimental protocol: In this protocol, the PAD system is trained and tested with the same type of PAI. Hence, this protocol allows the analysis of the robustness of the method to known PAI.

### Results and Discussion: Without Background Subtraction

This section discusses the quantitative performances of the EfficientNet method and the other PAD methods, without background subtraction. Thus, the features were computed directly on the received signal, and experiments were performed using inter and intra evaluation protocols.

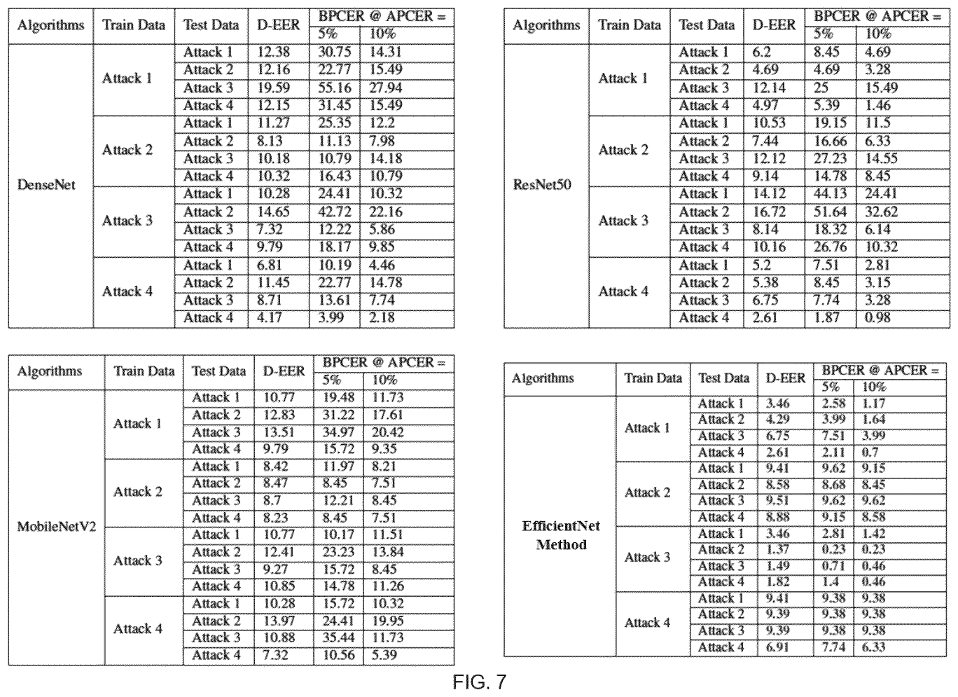

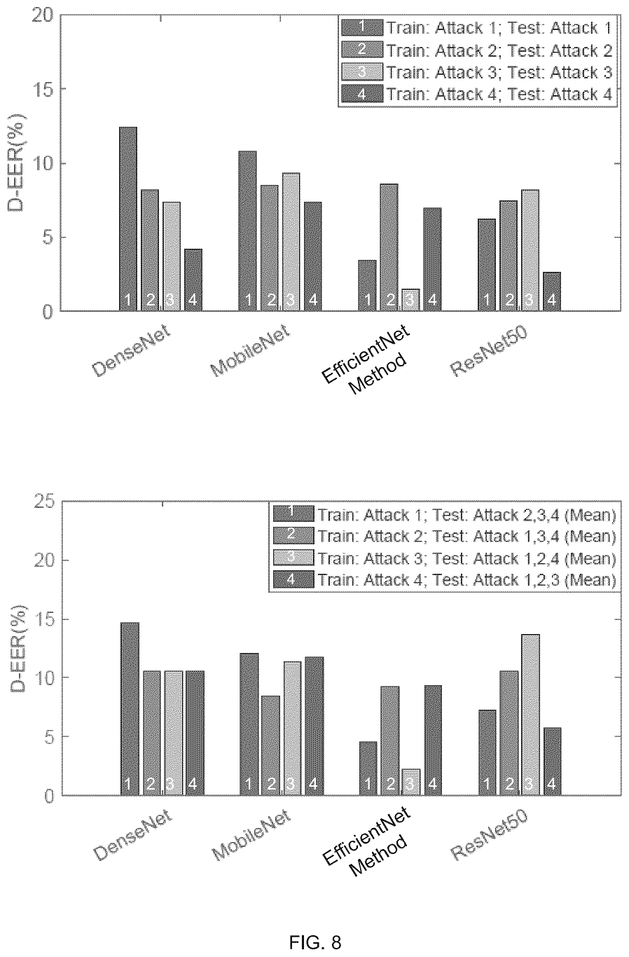

FIG. 7 shows the quantitative performances of the PAD methods. Attack 1 corresponds to a display attack; Attack 2 corresponds to a print-I attack; Attack 3 corresponds to a print-II attack; and Attack 4 corresponds to a silicone face mask attack. FIG. 7 presents the quantitative results of both the intra and inter evaluation protocols.

FIG. 8 shows two bar charts with D-EER (%) values for the intra evaluation protocol (upper graph) and inter (lower graph) evaluation protocol, comparing the EfficientNet Method with methods using other pre-trained CNNs, without background subtraction. The lower bar chart indicates the inter evaluation protocol in which the D-EER (%) is plotted by taking the mean of D-EER computed on test attacks.

Based on the obtained results, the following observations were made:
In general, the intra experiments indicate better results than the inter experiments on all four different PAIs. However, it is interesting to note that the difference in performance between intra and inter experiments on PAIs is not much different, indicating the generalizability of the acoustic signal analysis.
Among the four PAIs employed in this work, the attack potential of these PAIs depends on the type of feature extraction. For example, Attack 1 indicates the highest D-EER (%) with DenseNet features and Attack 3 indicates the highest D-EER (%) with MobileNet and ResNet50. Attack 2 indicated the highest D-EER of the EfficientNet method (%).
The feature extraction using EfficientNet has indicated the best performance on Attacks 1 and 3 in inter and intra-experiments compared to the three different pre-trained networks employed in this work. The EfficientNet method also indicated less performance variation between intra and inter evaluation protocols.

### Results and Discussion: With Background Subtraction

This section discusses the quantitative results of the EfficientNet and other PAD methods when background subtraction was performed. A benefit of the present transmission & reception pattern lies in the ability to record the background before the signal is transmitted and received. Therefore, we can subtract the background signal from the received signal to improve the SNR and contribute to reliable detection of PAI.

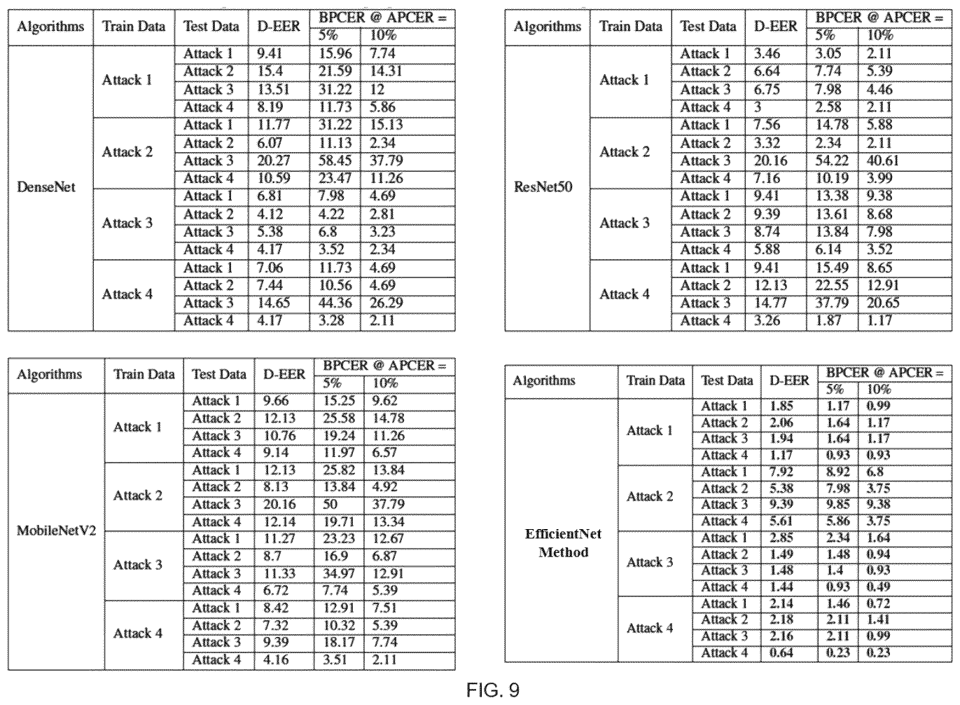

FIG. 9 presents the quantitative performances of the EfficientNet method and the use of other pre-trained models, with inter and intra evaluation protocols, with background subtraction.

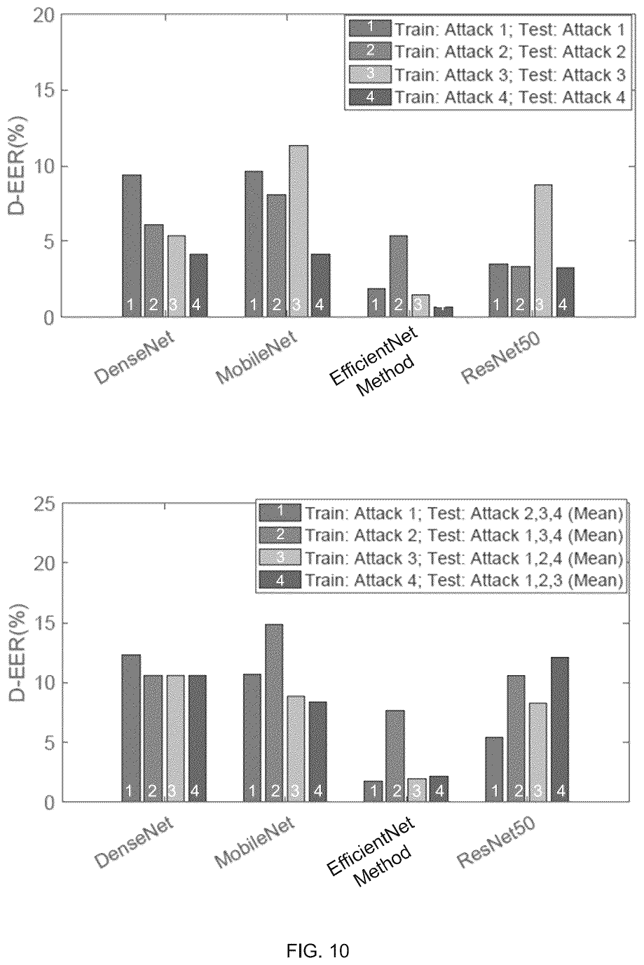

FIG. 10 shows two bar charts with D-EER (%) values for the intra evaluation protocol (upper graph) and inter (lower graph) evaluation protocol, comparing the EfficientNet method with methods using other pre-trained CNNs, with background subtraction.

Based on the results obtained, the following observations were made:
The detection error is less for the intra experiments compared to the inter experimental protocol with both EfficientNet and other feature extraction techniques. However, the average difference in performance between the intra and inter protocols was minimal. Therefore, the use of acoustic signals can result in a generalizable PAD.
Among the four PAIs employed in this work, the attack potential of these PAIs depends on the type of feature extraction. For example, Attack 1 indicates the highest D-EER (%) with DenseNet features, and Attack 3 indicates the highest D-EER (%) with MobileNet and ResNet50. Attack 2 indicates the EfficientNet method's highest D-EER (%).
The feature extraction using EfficientNet has indicated the best performance on inter and intra experiments compared to the three different pre-trained networks employed in this work. The results indicated the robustness of the EfficientNet method to background noise, as background noise subtraction was performed in these experiments.

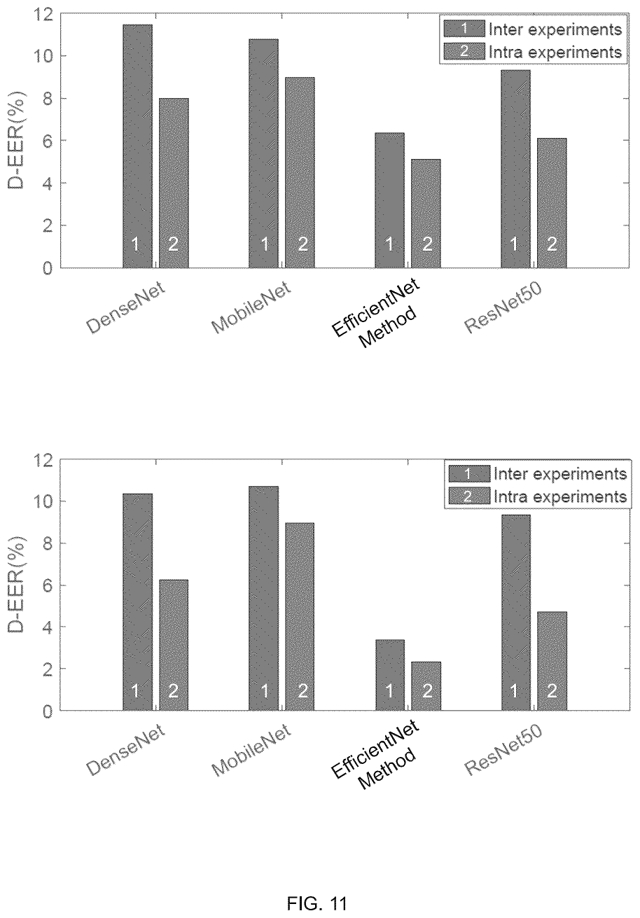

FIG. 11 shows the average performance of the EfficientNet and other feature extraction methods in the inter and intra experiments without background subtraction (upper plot) and with the background subtraction method (lower plot).

The following observations were made:
The detection performance of the PAD algorithms indicates improved performance when background subtraction is performed. This demonstrated the superiority of the transmission & recording schema disclosed herein.
The feature extraction based on the EfficientNet indicates the best performance with and without background subtraction compared to other feature extraction techniques.
The EfficientNet method indicates little difference between intra and inter-performance variation both with and without background subtraction. The EfficientNet method indicates an average D-EER (%) of 6.35(%) and 5.11(%) on inter and intra experiments without using background subtraction. With background subtraction, the EfficientNet method indicated an average D-EER (%) of 3.36(%) and 2.33(%) in inter and intra experiments respectively. The low difference in the performance of the EfficientNet method with inter and intra variations indicates the generalizability of the method.

### CONCLUSIONS

Reliable detection of unknown PA is important for enabling trustworthy face recognition applications on smartphones. In this experimental validation, we evaluated variants of a method for a generalizable face PAD on smartphones using acoustic sound echoes, according to the present disclosure. Recording before transmitting a signal based on a long pulse was used to effectively model the background noise and increase the signal-to-noise ratio. The reflected signals were processed to remove background noise and obtain the time-frequency representation. We then computed the deep features using pre-trained EfficientNet by extracting the features from the BatchNorm layer. The BatchNorm layer provides forty-nine different embeddings used to train forty-nine independent linear SVMs whose decisions are fused to make the final decision. Extensive experiments are presented here to benchmark the performance of the EfficientNet method using intra and inter evaluation protocols. Additional experiments are presented to highlight the utility of background subtraction in improving the robustness and accuracy of the face PAD. The obtained results demonstrated the generalizability of the EfficientNet method across unknown PAIs.

It will be appreciated by those skilled in the art that various exemplary embodiments have been described, but that the present disclosure is not limited to these embodiments; rather, many variations and modifications are possible, within the spirit and scope of the present disclosure.

1. A method of determining whether a presented face comprises an artificial facial presentation attack instrument, the method comprising:
transmitting an airborne acoustic signal towards the presented face;
receiving acoustic emissions from the presented face arising from the airborne acoustic signal;
sampling the received acoustic emissions to generate a sampled response signal;
applying one or more wavelet transforms to the sampled response signal to generate a wavelet-transformed signal;
processing the wavelet-transformed signal using a model, wherein the model has been trained using training data comprising wavelet-transformed signals for distinguishing between presented faces that comprise artificial facial presentation attack instruments and presented faces that do not comprise artificial facial presentation attack instruments; and
determining, in dependence upon an output of the model, whether the presented face comprises an artificial facial presentation attack instrument.

2. The method of claim 1, wherein the model comprises an artificial neural network module and a classifier module, wherein processing the wavelet-transformed signal using the model comprises:
processing, with the artificial neural network module, the wavelet-transformed signal to determine one or more deep features;
processing, with the classifier module, the one or more deep features to determine a score representing a probability that the presented face comprises an artificial facial presentation attack instrument; and
outputting the score from the model.

3. The method of claim 2, wherein the one or more deep features comprises a plurality of deep features, and the method comprises:
processing, with the classifier module, each of the plurality of the deep features to determine a respective sub-score; and
combining the plurality of sub-scores to determine the score.

4. The method of claim 3, wherein each of the plurality of deep features relates to a different sets of input nodes of the artificial neural network.

5. The method of claim 2, wherein the artificial neural network module comprises a pre-trained convolutional neural network.

6. The method of claim 2, wherein the classifier module comprises one or more support vector machines trained using the training data.

7. The method of claim 1, wherein applying one or more wavelet transforms to the sampled response signal comprises applying a plurality of different wavelet transforms to the sampled response signal to generate the wavelet-transformed signal.

8. The method of claim 1, wherein:
the transmitting of the airborne acoustic signal towards the presented face ceases at a first time;
the received acoustic emissions from which the sampled response signal is generated are received at an acoustic receiver and sampled during a time window starting after the first time; and
there is an interval between the first time and the start of the time window.

9. The method of claim 8, comprising receiving, at the acoustic receiver, one or more, or all, direct reflections of the airborne acoustic signal from an outer surface of the presented face before the start of the time window.

10. The method of claim 1, comprising:
transmitting the airborne acoustic signal for at least one second; and
sampling the received acoustic emissions for at least one second.

11. The method of claim 1, wherein the airborne acoustic signal comprises a sine wave having a frequency between 20 kHz and 22 kHz.

12. The method of claim 1, comprising:
sampling background noise to generate a background noise signal; and
using the background noise signal to remove background noise from the sampled response signal.

13. The method of claim 1, wherein the model has been trained for detecting presented faces that comprise an artificial facial presentation attack instrument comprising a displayed image or a mask.

14. A non-transitory computer-readable medium comprising instructions that, when executed on a processing system of an electronic device that comprises an acoustic transmitter and an acoustic receiver, cause the electronic device to:
transmit an airborne acoustic signal towards a presented face;
receive acoustic emissions from the presented face arising from the airborne acoustic signal;
sample the received acoustic emissions to generate a sampled response signal;
apply one or more wavelet transforms to the sampled response signal to generate a wavelet-transformed signal;
process the wavelet-transformed signal using a model, wherein the model has been trained using training data comprising wavelet-transformed signals for distinguishing between presented faces that comprise artificial facial presentation attack instruments and presented faces that do not comprise artificial facial presentation attack instruments; and
determine, in dependence upon an output of the model, whether the presented face comprises an artificial facial presentation attack instrument.

15. An electronic device comprising an acoustic transmitter and an acoustic receiver, wherein the electronic device is configured to perform the method of claim 1.

16. A method of determining whether a presented face comprises a facial presentation attack instrument, the method comprising:
transmitting an airborne acoustic signal from an acoustic transmitter towards the presented face;
ceasing transmission of the airborne acoustic signal at a first time;
one or more direct reflections of the airborne acoustic signal from an outer surface of the presented face arriving at an acoustic receiver during a first time window starting after the first time;
receiving, at the acoustic receiver, during a second time window starting after an end of the first time window, one or more further acoustic emissions from the presented face, arising from the airborne acoustic signal;
sampling the one or more further acoustic emissions to generate a sampled response signal; and
processing the sampled response signal to determine, in dependence upon the one or more further acoustic emissions, whether the presented face comprises a facial presentation attack instrument.

17. The method of claim 16, wherein whether the presented face comprises a facial presentation attack instrument is determined not in dependence upon any acoustic emissions received at the acoustic receiver during the first time window.

18. The method of claim 16, comprising processing the sampled response signal using a model, wherein the model has been trained for distinguishing between presented faces that comprise artificial facial presentation attack instruments and presented faces that do not comprise artificial facial presentation attack instruments.

19. A non-transitory computer-readable medium comprising instructions that, when executed on a processing system of an electronic device that comprises an acoustic transmitter and an acoustic receiver, cause the electronic device to perform the method of claim 16.

20. An electronic device comprising an acoustic transmitter and an acoustic receiver, wherein the electronic device is configured to perform the method of claim 16.
